(19) United States
(12) Patent Application Publication
(10) Pub. No.: US 2024/0313230 A1
(43) Pub. Date: Sep. 19, 2024

(54) Honeycomb Boron Carbon Nitride Nanomaterial Plated With Metal And Application Thereof

(71) Applicant: COUNCIL OF SCIENTIFIC AND INDUSTRIAL RESEARCH, New Delhi (IN)

(72) Inventors: Manjusha Vilas SHELKE, Pune (IN); Apurva Algesh PATRIKE, Pune (IN); Indrapal KARBHAL, Pune (IN)

(21) Appl. No.: 18/262,225

(22) PCT Filed: Jan. 20, 2022
(86) PCT No.: PCT/IN2022/050041

§ 371 Date: Jul. 20, 2023

(30) Foreign Application Priority Data
Jan. 20, 2021 (IN) 202111002835

(51) Int. Cl. H01M 4/66; B82Y 40/00; H01M 4/02; H01M 4/04; H01M 4/38; H01M 4/58; H01M 4/78; H01M 4/80; H01M 10/0525; H01M 10/0567; H01M 10/0568; H01M 10/0569

(52) U.S. Cl. CPC H01M 4/663; B82Y 40/00; H01M 4/0404; H01M 4/382; H01M 4/5825; H01M 4/78; H01M 4/80; H01M 10/0525; H01M 10/0567; H01M 10/0568; H01M 10/0569; H01M 2004/027; H01M 2004/028; H01M 2300/004; H01M 2300/0051

(57) ABSTRACT

The present invention discloses a 3D rigid mesoporous honeycomb boron carbon nitride (HBCN) nanomaterial as a host for plating/depositing metal. Said nanomaterial plated/deposited with metal is used as metal anode in alkali metal ion battery.

### FIELD OF THE INVENTION

The present invention relates to a 3D rigid mesoporous honeycomb boron carbon nitride (HBCN) nanomaterial as a host for plating/depositing the metal. Said nanomaterial plated/deposited with metal is used as metal anode in alkali metal ion battery.

### BACKGROUND AND PRIOR ART OF THE INVENTION

The state-of-art commercial Lithium ion battery (LIB) based on graphite and lithium transition metal oxide (LTMO) offers an energy density of ˜250 Wh kg⁻¹ which is quite insignificant in context of present energy density requirements of mobility applications (Richard Van Noorden, Nature, 2014, 507, 26, 2. Eric C. Evarts, Nature, 2015, 526, 593). The ideal anode and cathode combinations in the Li-ion architecture do not even reach close to the projected values for low weight electric vehicles and the practical Li-ion battery is saturated at a real capacity of 6 mAhcm⁻² (Goodenough J B, Park K S, Journal of the American Chemical Society, 2013, 135(4), 1167-76). However, replacement of graphite by lithium metal, i.e., revisiting the Li metal architecture has generated new hopes owing to higher expected energy densities that nearly match with the present demands. For example, current commercial graphite-based LIBs can have energy densities in the range of 100-265 Whkg⁻¹; whereas Li and LTMO battery can deliver the energy density of ˜440 Wh kg⁻¹. Further with Li metal as anode in Li—S and Li—O₂ architecture energy density of 600-650 Wh kg-1 and 900-950 Wh kg⁻¹ can be touched respectively (Bruce P G, Freunberger S A, Hardwick L J, Tarascon J M, Nature materials, 2012, 11, 19-29.9).

However, high reactivity of lithium poses formidable challenge of dendrite growth and subsequent shorting of the cells implying serious safety issues. The uncontrolled dendrite growth in case of Li is also contributed by uneven electrodeposition and huge volume changes which directly influences the solid electrolyte interpahse (SEI) that forms over the electrode materials. Thus, along with high reactivity of Li the main initiators of dendrite formation are—1) non-uniform Li flux due to cation depletion, 2) inhomogeneous nucleation due to heterogeneous Li conductivity, 3) cracks on the SEI due to large volume variation and resulting stresses. Of late, some strategies have been demonstrated to understand and counter these initiators with an intention to suppress dendrite growth for a stable Li anode performance. Apart from some electrolyte engineering most of the literature has been directed towards surface and bulk modifications of potential Li hosts. Moreover, pristine carbon networks provide conducting pathway to guide lithium plating. However, modification in carbon matrix such as incorporation of lithiophilic hosts in carbon improves the efficiency for lithium deposition by suppressing dendrite and regulating lithium deposition (Lithiophilicity chemistry of heteroatom-doped carbon to guide uniform lithium nucleation in lithium metal anodes” by Xiang Chen et. al Sci. Adv. 2019; 5: eaau7728, 15 Feb. 2019). Heteroatoms like nitrogen and boron help to provide proper contact with lithium due to electron rich nature which helps in uniform lithium deposition over the electrode surface. Stable coulombic efficiency and cycle life is achieved by uniform lithium deposition due to guided plating of dopants present in carbon matrix.

Considering all these, herein, first time nitrogen and boron doped mesoporous 3D honeycomb boron carbon nitride (HBCN) nanomaterial as host material to deposit lithium into pores and applied as lithium metal anode in Li-ion battery is provided being the need of the art.

### OBJECTIVES OF THE INVENTION

The main objective of the present invention is to provide a boron carbon nitride (BCN) plated with metal characterized in that the BCN material possesses honeycomb morphology.

The other objective is to provide and in-situ process for the preparation of mesoporous 3D honeycomb boron carbon nitride (HBCN) nanomaterial.

Another objective of the present invention is to provide a battery comprising the 3D honeycomb structured boron carbon nitride as metal anode.

### SUMMARY OF THE INVENTION

Accordingly, the present invention provides a 3D rigid mesoporous honeycomb boron carbon nitride (HBCN) nanomaterial with porosity in the range of 300 to 500 nm and mesoporosity in the range of 2 to 10 nm as host for plating/depositing the metal.

The metal to be deposited is selected from lithium, sodium, magnesium or aluminum.

In an aspect, the 3D rigid mesoporous nanomaterial of boron carbon nitride (HBCN) has a surface area in the range of 400-800 m² g⁻¹.

In another aspect, the present invention provides a cost effective process for preparation of the 3D honeycomb boron carbon nitride comprising the steps of:
a) Adding tetraethyl orthosilicate (TEOS) into a mixture of water, alcohol and ammonium solution followed by stirring to afford reaction mixture;
b) Adding TEOS solution into the mixture of step (a) and continuing the stirring to afford silica nanoparticles;
c) Separating the silica nanoparticles of step (b) by centrifugation and washing followed by drying to afford dried colloidal silica nanoparticles SiO₂ NPs;
d) Infiltrating a mixture of boric acid, carbon precursor and cyanamide solution with colloidal SiONPs and drying the resulting material followed by pyrolysis in inert gas to afford silica NPs/BCN; and
e) treating the silica NPs/BCN of step (d) with HF solution to completely dissolve/remove SiO₂ NPs from the product followed by washing and drying to obtain 3D honeycomb Boron Carbon Nitride (HBCN).

The 3D rigid mesoporous honeycomb boron carbon nitride (HBCN) nanomaterial with porosity in the range of 300 to 500 nm and mesoporosity in the range of 2 to 10 nm plated/deposited with metal is used as anode material for alkali metal ion battery.

In another aspect, the present invention provides an anode for the alkali metal battery comprising the 3D honeycomb boron carbon nitride with porosity in the range from 300 to 500 nm and in mesoporosity in the range of 2 to 10 nm with the alkali metal ion plated/deposited on to said honeycomb boron carbon nitride mesoporous structure.

The alkali metal ion battery may comprise Lithium ion battery, lithium-sulphur battery, sodium ion battery, sodium-sulphur battery. The metal to be deposited is selected from lithium, sodium, magnesium or aluminum, preferably lithium and sodium.

In an aspect, the present invention provides Lithium ion battery with improved stability, long lifecycle comprising 3D honeycomb boron carbon nitride with porosity in the range from 300 to 500 nm and mesoporosity in the range of 2 to 10 nm plated/deposited with lithium as metal anode.

In another aspect, the present invention provides alkali metal plated Full cell comprising:
(i) the cathode;
(ii) the anode comprising 3D honeycomb boron carbon nitride with porosity in the range of 300 to 500 nm and mesoporosity in the range of 2 to 10 nm plated/deposited with alkali metal ion;
(iii) the electrolyte arranged between the cathode and the anode comprising an alkali salt and solvent; and
(iv) the separator.

### BRIEF DESCRIPTION OF THE DRAWINGS

FIG. 1: (a) XRD patterns and (b) Raman Spectra of carbon sheets, honeycomb carbon, BCN sheets, HBCN

FIG. 2: SEM images of (a) carbon sheets (b) honeycomb carbon (c) BCN sheets, and (d) HBCN

FIG. 3: (a) XPS survey spectrum of BCN, High resolution XPS spectrum of (b) B1s, (c) C1s and (d) N1s of BCN

FIG. 4: (a) High-resolution XPS spectra of C1s (b) B1s and (c) N1s of HBCN

FIG. 5: N2 adsorption isotherm (a and c) and pore size distribution (b and d) for carbon sheets and HBCN samples respectively.

FIG. 6: (a) SEM image of silica nanoparticles (b) SEM images of Silica NPs/BCN after heating at 900° C., (c-e) SEM images, (f-g) TEM images, (h) SAED pattern of, (i) high-angle angular dark-field scanning transmission electron microscopy (HAADF-STEM) images of 3D HBCN, (j) TEM elemental mapping of boron, (k) elemental mapping of carbon, (l) elemental mapping of nitrogen.

FIG. 7: Plating-stripping performance of HBCN at 4 mAcm⁻² and 10 mAhcm⁻² (a) Voltage-time profile, (b) Plating-stripping coulombic efficiency, (c) Voltage profiles for selected cycles of plating-stripping, (d) Evolution of hysteresis with plating-stripping cycles.

FIG. 8: (a) Voltage-time profile and (b) coulombic efficiency for rate performance of HBCN at 2 mAhcm⁻² areal capacity depositions, (c) Full cell performance of plated HBCN and LFP at 50 mAg⁻¹ current density and (d) charge-discharge profiles for the full cell.

FIG. 9: Li plating/stripping performance at 4 mAcm⁻² current and 10 mAhcm⁻² capacity. (a, c and d) Voltage vs time plot and (b, d and f) Coulombic efficiency vs cycle plot for carbon sheets, HC and BCN respectively.

FIG. 10: Li plating-stripping performance of HBCN at 8 mAcm⁻² current density and 10 mAhcm⁻² capacity value. (a) Voltage vs time plot, (b) Cycling stability with plating stripping coulombic efficiency, (c) Voltage profiles for selected cycles and (d) Evolution of voltage hysteresis with cycling.

FIG. 11: Electrochemical Na plating stripping for HBCN at 8 mAcm⁻² current density with varying Na intake capacity values. (a and c) V vs time plot at 2 mAcm⁻² and 1 mAhcm⁻² capacity values respectively. (b and d) Columbic efficiency plot at 2 mAhcm⁻² and 1 mA hcm⁻² capacity values respectively.

### DETAILED DESCRIPTION OF THE INVENTION

The invention will now be described in detail in connection with certain preferred and optional embodiments, so that various aspects thereof may be more fully understood and appreciated.

In an embodiment, the present invention relates to a 3D rigid mesoporous honeycomb boroncarbon nitride (HBCN) nanomaterial with porosity in the range of 300 to 500 nm and mesoporosity in the range of 2 to 10 nm as a host for plating/depositing the metal.

The metal to be deposited is selected from lithium, sodium, magnesium or aluminum.

In an embodiment, the 3D rigid mesoporous nanomaterial of boron carbon nitride (HBCN) has a surface area in the range of 400-800 m² g⁻¹.

In another embodiment, the present invention discloses the cost-effective process for preparation of the 3D honeycomb boron carbon nitride comprising the steps of:
a) Adding tetraethyl orthosilicate (TEOS) into a mixture of water, alcohol preferably isopropyl alcohol and ammonium solution followed by stirring at a temperature in a range of 25° C. to 30° C. for a time range of 1 to 2 hours to afford reaction mixture;
b) Adding TEOS solution into the mixture of step (a) and continuing the stirring for 2 to 4 hours at a temperature in a range of 25° C. to 40° C. to afford silica nanoparticles;
c) Separating the silica nanoparticles of step (b) by centrifugation and washing with water and alcohol followed by drying to afford dried colloidal silica nanoparticles SiO₂ NPs;
d) Infiltrating a mixture of boric acid, carbon precursor and cyanamide solution with colloidal SiO₂ NPs and drying the resulting material at a temperature in the range of 50° C. to 100° C., followed by pyrolysis at a temperature in a range of 700° C. to 1000° C. in inert gas for 2 to 4 h to afford silica/BCN; and
e) Treating the silica/BCN of step (d) with HF solution for 10 to 14 hours to completely dissolve/remove SiO₂ NPs from the product followed by washing with water and drying to obtain 3D honeycomb Boron Carbon Nitride (HBCN).

The carbon precursor is selected from glucose, sucrose, cellulose or fructose.

The process for preparation of the honeycomb boron carbon nitride is as shown in Scheme 1 below:

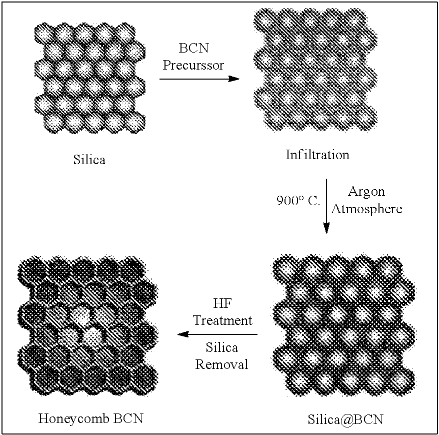

In an embodiment, the 3D honeycomb boron carbon nitride with porosity in the range from 300 to 500 nm and in mesoporosity in the range of 2 to 10 nm with plated/deposited ion is used as metal anode in alkali metal battery.

In still another embodiment, the present invention discloses an anode for the alkali metal battery comprising the 3D honeycomb boron carbon nitride with porosity in the range from 300 to 500 nm and in mesoporosity in the range of 2 to 10 nm plated/deposited with the alkali metal ion on to said honeycomb boron carbon nitride mesoporous structure.

The alkali metal ion is deposited on to the 3D honeycomb boron carbon nitride structure via electrochemical route.

The metal is selected from lithium, sodium, magnesium or aluminum. Preferably, the metal is lithium. The alkali metal ion battery may comprise Lithium-ion battery, lithium-sulphur battery, sodium ion battery, sodium-sulphur battery

In an embodiment, the 3D HBCN of the present invention itself is conducting in nature with interconnected structure and heteroatoms like B and N dopants provide guided path for smooth Li/Na plating over the surface.

In an embodiment, the 3D HBCN show stable and dendrite free Li plating/stripping performance for more than 2400 cycles at 8 mAcm⁻² high current and heavy Li intake of 10 mAhcm⁻² capacity.

In a preferred embodiment, the present invention relates to a Lithium ion battery comprising 3D honeycomb boron carbon nitride with porosity in the range from 300 to 500 nm and mesoporosity in the range of 2 to 10 nm plated/deposited with lithium as anode material.

In another embodiment, the process for preparation of the pre-lithiated electrode to be used as anode after deposition of lithium in Lithium ion battery comprises:
(i) Mixing 3D HBCN with porosity in the range from 300 to 500 nm and mesoporosity in the range of 2 to 10 nm, conducting additive (super P) and PVDF binder in a ratio of 80:10:10 in NMP solvent;
(ii) Coating the as prepared slurry of step (i) on copper foil used as current collector and subsequently drying overnight; and
(iii) Cutting the circular electrodes in 14 mm diameter.

In an embodiment, the lithium metal battery (half-cell) of the present invention with 3D HBCN as Li metal anode show 99.98% coulomb efficiency (CE) when subjected to 8 mAhcm⁻² high current density and 10 mAhcm⁻² heavy Li intake capacity values for more than 2400 cycles in 1 M LiTFSI and 0.3 M LiNO₃ in dioxolane (DOL)/dimethoxyethane (DME) electrolyte.

In yet another embodiment, the present invention disclose the Lithium plated Full cell comprising:
a) standard LifePO₄ (LFP) as cathode;
b) 3D honeycomb boron carbon nitride with porosity in the range from 300 to 500 nm and in mesoporosity in the range of 2 to 10 nm plated/deposited with lithium as anode;
c) Electrolyte comprising IM LiPF₆ in EC/DMC/EMC (i.e., ethylene carbonate/dimethyl carbonate/ethyl methyl carbonate) in 1:1:1 by v/v/v with 5% Fluoroethylene carbonate (FEC); and
d) Quartz fiber paper or Celgard as separator to separate negative and positive electrodes.

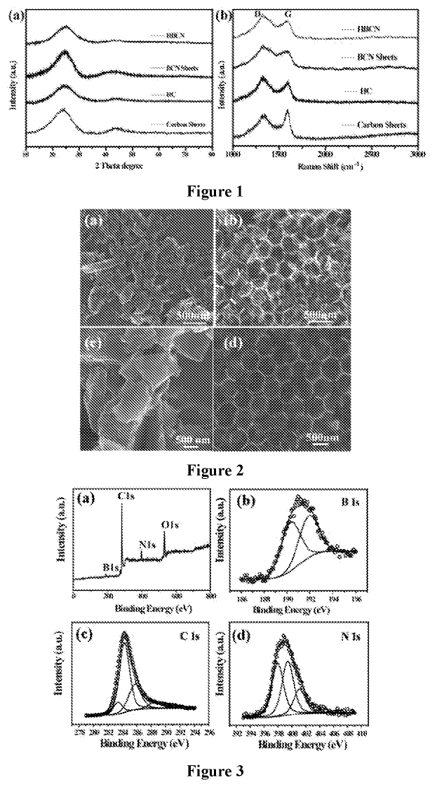

With reference to the figures, the detailed explanation of the present invention is as follows: Accordingly, the PXRD patterns of carbon sheets, honeycomb carbon, BCN sheets, HBCN shown in the FIG. 1 (a) depict two broad peaks for major planes of (002) and (100), indicating graphitic carbon nature.

Raman analysis was performed for carbon sheets, honeycomb carbon, BCN sheets, HBCN as shown in the FIG. 1 (b). The Raman spectra of all the samples exhibit the presence of D-band as well as G-band. G-band corresponds to in plane carbon atom stretching vibrations due to sp² carbon whereas D band also known as defect band is due to the presence of sp³ carbon. Carbon sheets, honeycomb carbon, BCN sheets, and HBCN show Raman shifts for the D-band with peak position at around 1325 cm⁻¹. Similar Raman shift phenomenon also observed in the G-band positions showing peaks at around 1588 cm⁻¹.

FIG. 2 shows SEM images of carbon sheets, honeycomb carbon, BCN sheets and HBCN samples. It clearly shows the sheet like morphology and honeycomb for both carbon and BCN samples.

XPS analysis shows presence of B, C, N and O in BCN. (FIG. 3a). Therefore, elemental analysis was carried out for these elements and FIG. 3b shows B1s spectrum that can be deconvoluted in two peaks at binding energies of 190.3 and 191.9 eV related to B—C and B—N bonds respectively. FIG. 3c is C1s spectrum deconvoluted into four peaks at 283.4, 284.3, 285.7 and 288.5 eV, which are assigned to C—B, C—C, C—N and C—O respectively. N1s spectrum is shown in FIG. 3d, deconvoluted into three peaks at 397.9, 399.41 and 401.12 eV corresponding to N—B, N—C(pyridinic and graphitic). All peaks thus confirm the formation of bonds between C—B, C—N, C—O, and B—N.

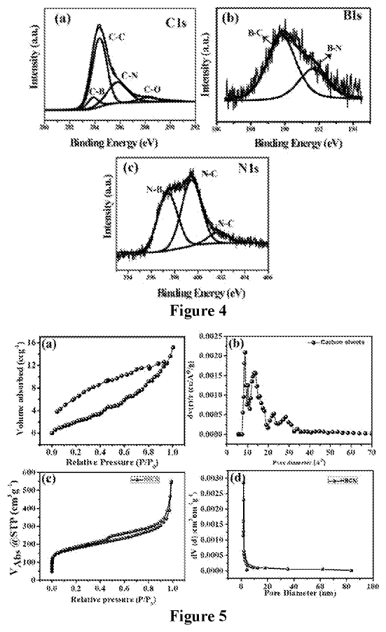

The high-resolution X-ray photoelectron spectroscopy (XPS) spectra of the C1s of H—BCN (FIG. 4a) could be deconvoluted to 283.8, 284.3, 285.8 and 288.2 eV, which are attributed to C—B, C—C, C—N and C—O bonds respectively. The high-resolution spectra of B1s of H—BCN (FIG. 4b) show two deconvoluted peaks at 189.8 and 191.6 corresponding to the B—C and B—N bonds respectively. Similarly, the high-resolution spectra of the N1s of H—BCN (FIG. 4c) depict three deconvoluted peaks at 397.3, 399.4 and 401.7 eV, because of N—B, N—C pyridinic and N—C graphitic bonds respectively. The XPS study gives insight of B and N doping into honeycomb shaped carbon (HBCN) for metal anode application where e deficient B is making bond between C and N and e⁻ rich N offers lone pair of electron and acts as Lewis base to strongly adsorb Lewis acid Li⁺ ions through strong acid-base reaction.

The specific surface area for honeycomb BCN, BCN sheets, honeycomb carbon and carbon sheets were observed to be 597, 358, 276 and 10 m² g⁻¹ respectively. The N₂ adsorption desorption isotherm and pore size distribution for carbon sheets and HBCN are shown in FIG. 5. Carbon sheets exhibited 10 m² g⁻¹ surface area with type III isotherm (FIG. 5a) and pore size (FIG. 5b) distribution in 10-30 nm. However, HBCN exhibited highest surface area among all prepared carbon samples which was 597 m² g⁻¹ with type IV isotherm (FIG. 5c) and pore size (FIG. 5d) ranging below 20 nm.

TABLE 1
BET surface area of HBCN, BCN sheets,
honeycomb carbon, carbon sheets

| | Honey | | Honeycomb | |
|---|---|---|---|---|
| | BCN | BCN Sheets | Carbon | Carbon Sheets |
| Surface area | 597 | 358 | 276 | 10 |
| (m²g⁻¹) | | | | |

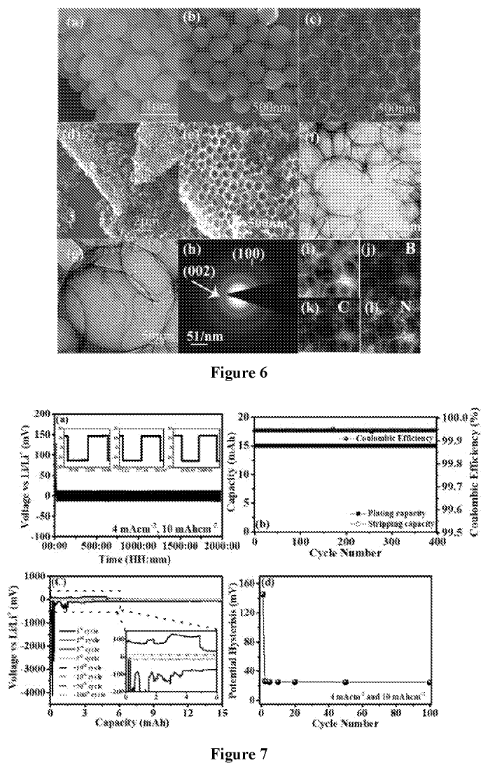

In an embodiment of the present process, uniform spherical Silica NPs of size (around 500 nm) were prepared by using well-known Stober method. Moreover, with Stober method, silica NPs of size ranging from 50 to 500 nm could be synthesized. In this invention, silica NPs of size around 300-500 nm were synthesized. The formation of uniform spherical Silica NPs was confirmed by the SEM image (FIG. 6a). Glucose, (or cellulose or sucrose or fructose can also be used as carbon precursor) boric acid and cyanamide mixture was then infiltrated by the Silica NPs, followed by pyrolysis at 900° C., resulting in the formation of a uniform BCN layer on the Silica NPs as confirmed from the SEM image (FIG. 6b). In the present process, the random formation of any lumps from the precursors were not observed. FIG. 6(c-e) depict the SEM images of the HBCN obtained after etching of the Silica NPs with HF solution from the Silica NPs/BCN composite. The diameter of the spherical pores formed on BCN layers after etching of the Silica NPs, is almost similar to the Silica NPs, creating the 3D architecture. The 3D architectures were created uniformly throughout the BCN and tends to induce the honeycomb sponge like structure in the BCN material. Further, the porous nature and the structural morphology of the 3DHBCN was examined by the TEM imaging and the TEM images are shown in the FIG. 6 (f and g) displaying honeycomb-like porous 3D morphology of HBCN. FIG. 6(h) illustrates a selected-area electron diffraction (SAED) pattern of the HBCN. The diffused diffraction rings indicate amorphous/polycrystalline nature. The diffraction rings correspond to (002) and (100) planes of carbon. Elemental mapping of 3DHBCN was done in TEM and corresponding images are shown in FIG. 6 (i-l). The elemental mapping images show even distribution of B, C & N in the 3DHBCN material.

The phase purity and crystalline structure of 3D HBCN network was characterized by powder XRD. The diffraction pattern observed for the carbon material is shown in FIG. 1 (a). The broad peaks for major crystallographic planes (002) and (001) of graphite indicate turbostratic nature. The d-values for the (002) plane from the PXRD patterns of HBCN were 3.5 nm. In order to get the deeper structural information Raman spectrum was taken at the excitation wavelength of 632.8 nm. The Raman plot is shown in FIG. 1 (b). Two strong peaks were observed at 1325 cm⁻¹ and 1594 cm⁻¹ which correspond to D-band and G-band of graphite respectively. This prominent defect band could be for two reasons, high porosity of the carbon and presence of nitrogen and boron doping in the 3D HBCN network along with oxygen functional groups. Additionally, a weak broader signature at 2689 cm⁻¹ corresponding to 2D-band of graphite was observed which implies the stronger 3D linkages in the carbon network. The Nitrogen adsorption-desorption studies were performed to understand the porous nature of the HBCN material and corresponding plots are shown in FIGS. 5(c) and (d). The isotherm for HBCN shown in FIG. 5c represents type-IV isotherm indicating monolayer N2 adsorption at lower relative pressure and hysteresis at higher relative pressure indicates presence of mesopores in the HBCN with total surface area of 597 m² g⁻¹. Pore size distribution derived from the Nitrogen desorption curves showed total pore volume of 0.84 cm³ g⁻¹. The high surface area and pore volume enhanced in Li plating-stripping performance as a short diffusion path of Li-ion, providing excellent accessibility for active sites, showed good electrode-electrolyte contact. Such high surface area shall imply low current densities and hence a uniform flux for lithium deposition.

This interconnected nanoscale carbon provided the basic large lithiophilic carbon surface for Li electrodeposition during the charging. The porous structure ensures the facile diffusion to mitigate the non-uniform Li flux that causes the development of local space charges which in turn could lead to dendrite. Additionally, the heteroatom doping could functionalize the surface for better lithiophilicity.

Lithium deposition/dissolution, i.e., plating/stripping behavior on as prepared HBCN material was studied in half cell assembly. Coulombic efficiency is the prime parameter to investigate sustainability of any lithium metal anode. Coulombic efficiency is the ratio of total amount of lithium stripped from the working electrode to the total amount of lithium deposited on the working electrode. During plating. Li⁺ ions deposit on working electrode from Li disc counter electrode and in stripping Li⁺ ions get stripped and return back to the Li disc counter electrode. Generally coulombic efficiency depends on both current density and areal capacity. Hence, it is important to study any lithium metal anode at different current density and areal capacity values. The plating-stripping behavior for HBCN coated on copper foil at 4 mAcm⁻² current density and 10 mAhcm⁻² areal capacity values is shown in FIG. 7. From FIG. 7(a), stable and uniform voltage profile for HBCN was identified from 1^{st} cycle itself. Uniform plating-stripping behavior for HBCN was observed over 400 cycles with 99.94% coulombic efficiency (FIG. 7(b)). This enhanced performance was attributed to uniform flux distribution on high surface area HBCN material which provides interconnected carbon network at nanoscale. Moreover, nitrogen and boron doping in carbon matrix played crucial role where nitrogen and boron regulates lithium nucleation, provides guided lithium plating and thereby suppresses the dendrite growth. This helps in stable long-term cycling performance. Owing to high apparent area (surface area), HBCN experiences a very low current density thus extending the dendrite formation time and maintains a stable stress free SEI over the period of cycling.

FIG. 7(c) depicts the Li electro-deposition over-potential from the voltage difference between flat plateau of plating and stripping potentials. The net over potential may originate from: (i) Li⁺ ion diffusion limitations through SEI (ii) charge transfer over potential for plating. The over potential for the Li deposition on HBCN coated copper is around 145.2 mV for first cycle. From FIG. 7c, for first plating, potential drops to −4000 mV vs. Li/Li⁺ which was maximum potential drop in the whole experiment carried out at 4 mAcm⁻² current density and 10 mAhcm⁻² capacity values which is attributed to kinetic hindrance experienced by Li⁺ ions for transport through SEI at such high current rate and capacity value. However, over potential decreases drastically and stabilizes from 2^{nd} cycle itself. This decrease in over potential during cycling was attributed to deposition of new Li⁺ ions on the previously deposited ions. Over potential of 26.6, 26.2, 25.5, 25.3 and 25.4 mV was observed for 2^{nd}, 3^{rd}, 5^{th}, 10^{th} and 20^{th} cycle and which became stable after 100 cycles with the vales of 24.6 mV as shown in FIG. 7(d). Over potential got stabilized from 2^{nd} cycle itself which is contributed to the robust SEI layer formed over mesoporous structure allowing efficient transport of Li⁺ ions through it. The coulombic efficiency (CE) value was retained even after 400 cycles which amounts to plating-stripping of 2000 h.

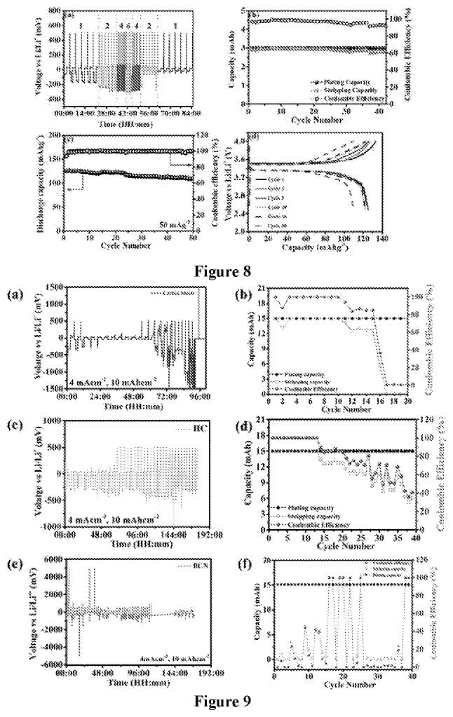

Rate performance of HBCN was carried out at constant areal capacity of 2 mAhcm⁻². (FIGS. 8(a) and (b)) Areal current densities in sequence of 1, 2, 4, 6, 4, 2 and 1 mAcm⁻² were applied to HBCN. Stable coulombic efficiency performance was achieved at different current values with negligible potential drop at different current rates. This was ascribed to mesoporous structure with dual heteroatom doping into carbon matrix which regulates lithium flux over surface even at higher current rates.

In another embodiment, the feasibility of lithium plated HBCN in full cell was studied in full cell configuration using LiFePO₄ (LFP) as cathode and prelithiated HBCN as an anode. The charge-discharge cycling performance for Li-HBCN∥LFP full cell at 50 mAg⁻¹ current density is shown in FIG. 8(c and d) respectively. The full cell shows capacity values of 110 mAhg⁻¹ after 50 cycles with 100% coulombic efficiency.

Li plating/stripping performance for Carbon sample at 4 mAcm⁻² current and 10 mAhcm⁻² capacity indicating very poor performance is shown from voltage vs time plot and coulombic efficiency vs cycle plot in FIGS. 9(a) and (b) respectively. This is due to very less surface area of material which provides lower Li nucleation sites and planar surface causes inhomogeneous Li deposition which further develops into dendrite growth. Moreover, absence of hetero-doping in C results in poor anchoring of Li which ends in poor performance. Within 20 cycles of plating/stripping, coulombic efficiency drops down rapidly.

Similar to plane carbon sheets, honeycomb carbon (HC) sample also shows poor Li plating/stripping performance at 4 mAcm⁻² current and 10 mAhcm⁻² capacity (FIG. 9 (c and d)). Coulombic efficiency drops down within 40 cycles itself. As compared to plane carbon sheets, higher surface area of HC helps in larger Li nucleation sites. However, lithio-phobic nature of carbon and lack of lithiophilic functional groups with strong binding affinity towards lithium atoms results in poor performance. Therefore, this results in inhomogeneous Li flux distributions and dendrite growth.

Li plating/stripping performance for BCN material at 4 mAcm⁻² current density and 10 mAhcm⁻² capacity value is shown in FIG. 9 (e and f) respectively. Similar to planar carbon and honeycomb carbon materials, poor Li plating/stripping performance was observed for BCN material. In case of BCN, although B and N lithiophilic dopants are present, sheets like morphology provides inhomogeneous Li flux distribution in material which results in poor performance.

Battery performance of planar carbon sheets, honeycomb carbon, BCN sheets and honeycomb BCN indicates that both honeycomb structure and B—N doping into carbon are optimum requirements for uniform Li plating/stripping application.

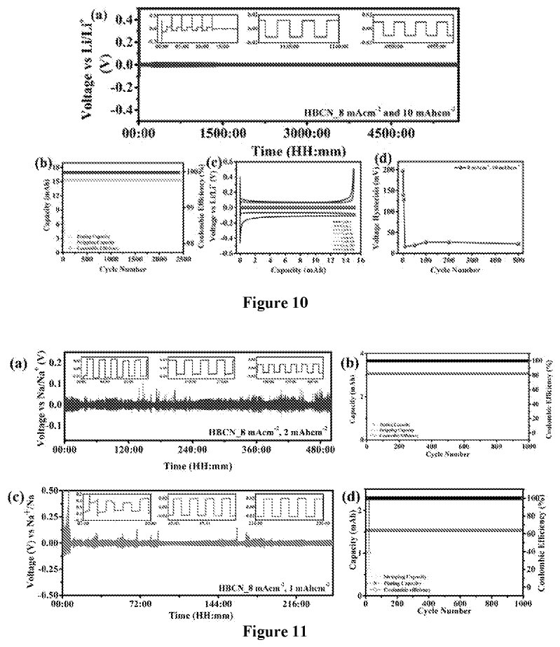

FIG. 10 depicts the experimental results of plating stripping performance of HBCN at high current density of 8 mAcm⁻² and heavy Li deposition of 10 mAhcm⁻². From the first inset graph of FIG. 10 (a), it easily indicates that for initial few cycles, the nature of V vs time plot is not uniform. The reason being, kinetic hindrance offered to Li⁺ for transport through electrolyte as well as through solid electrolyte interface as plating occurs beneath SEI layer. However, the performance gets stabilized within 10 cycles. The coulombic efficiency obtained at such high current rate with heavy Li deposition capacity is impressive and which is equal to 99.98% after 2437 cycles. (FIG. 10 (b)) This enhanced performance is attributed to uniform flux distribution on high surface area HBCN material with interconnected carbon network at nanoscale. Moreover, nitrogen and boron doping in carbon matrix plays crucial role where nitrogen and boron regulates lithium nucleation, provides guided lithium plating and thereby suppresses the dendrite growth. This helps in stable long-term cycling performance.

FIG. 10(c) also gives the idea about kinetics of Li deposition in terms of Li electro-deposition over-potential calculated from the voltage difference between flat plateau of plating and stripping potentials. The net over potential may originate from: (i) Li⁺ ion diffusion limitations through SEI and (ii) charge transfer overpotential for platting. The nucleation overpotential for the Li deposition on HBCN is around 461.3 mV for first cycle which is highest for the current experiment at 8 mAcm⁻² and 10 mAhcm⁻² parameters and can be attributed to kinetic hindrance offered to Li⁺ for transport through SEI. For 2^{nd} cycle, the nucleation overpotential drastically decreased to 87.4 mV and further gets stabilized. Furthermore, voltage hysteresis in plating stripping is termed as overpotential and is the difference between flat plateau of plating voltage and stripping voltage. This gives an idea about mass transport behavior of Li during plating stripping cycling. Overpotential of 197.3, 139.8, 128.65, 16.7, 19.1, 26.5, 26.7 and 22.7 mV are observed for 1^{st}, 2^{nd}, 5^{rd}, 10^{th}, 50^{th}, 100^{th}, 200^{th} and 500^{th} which becomes stable after 500 cycles with the vales of around 22 mV as shown in FIG. 10(d). Overpotential get stabilized from 2^{nd} cycle itself which is contributed from robust SEI layer formed over mesoporous structure allowing efficient transport of Li⁺ ions through it.

In yet another embodiment, the 3D HBCN of the present invention when subjected to sodium metal anode application, show stable performance even after 1000 cycles at 8 mAcm⁻² current 1 and 2 mAhcm⁻² capacity values with ˜100% coulombic efficiency shown in FIG. 11. Stable electrochemical performance confirms HBCN allows uniform Li deposition and stable interface. The conductive carbon matrix with larger surface area and mesoporous structure implies distribution of low current densities and facilitated Li⁺ ions transport with uniform electron and Li⁺ ion distribution. Moreover, boron and nitrogen dopants act as active sites for homogeneous Li nucleation with guaranteed dendrite free Li deposition. The enlarged pore volume incorporates infinite volume expansion issue by providing space which leads to persistent interface.

The as-prepared HBCN anode exhibits excellent electrochemical performance and the high stability in Li batteries with 99.98% coulombic efficiency when subjected to high current of 8 mAcm⁻² and heavy Li intake deposition capacity of 10 mAhcm⁻² for more than 2400 cycles. The full cell assembly of prelithiated HBCN with LFP cathode shows stable performance over 50 cycles. This rational designed carbon matrix provides an effective strategy for fabricating of stable Lithium metal anode (LMA) as well as Sodium metal anode (NMA).

In an embodiment, the present invention provides 3D HBCN which show stable and dendrite free Li plating/stripping performance for more than 2400 cycles at 8 mAcm⁻² high current and heavy Li intake of 10 mAhcm⁻² capacity. Further, the invention discloses easy and cost effective template assisted synthesis of 3D HBCN.

When a cell is fabricated with an anode or cathode against Lithium metal then it is called “Half Cell”. When a cell is fabricated with anode and cathode against each other then it is called a “Full Cell”.

### EXAMPLES

Following examples are given by way of illustration and therefore should not be construed to limit the scope of the invention.

### Materials:

Glucose, Cyanamide and tetraethyl orthosilicate (TEOS), boric acid and isopropyl alcohol (IPA), ammonia solution were procured for synthesis of HBCN. Conducting carbon (carbon black-99.99%), polyvinylidene fluoride (PVDF) and N-methyl-2-pyrrolidone used for the preparation of electrodes.bis(trifluoromethane)sulfonimide lithium salt (LITFSI), dioxolane (DOL), dimethoxyethane (DME), lithium nitrate (LiNO₃), lithium hexafluorophosphate (LiPF₆), ethylene carbonate (EC), dimethyl carbonate (DMC), fluoroethylene carbonate (FEC), NaPF₆ and Diglyme were used for the preparation of electrolyte. Lithium discs, sodium metal and Celgard separator were used in battery fabrication. All materials were used as received.

Silica NPs were synthesized by well-known Stober method with NPs of size in range from 300 to 500 nm and used as templates for HBCN synthesis. In general silica NPs of size ranges from 50 to 500 nm can also be synthesized using Stober method. Moreover, commercial silica NPs of required size range can also be procured for further synthesis of HBCN.

### Example 1: Synthesis of 3D Honeycomb Boron Carbon Nitride (HBCN)

Template assisted synthesis protocol has been employed for HBCN synthesis where SiO₂ NPs were used as template. Typically, 1 mole of each of boric acid, glucose and cyanamide solution was infiltrated with colloidal SiO₂ NPs. After the infiltration of the solution, the resulting material was dried at 60° C., followed by pyrolysis at 900° C. in Argon gas for 3 hours. Subsequently, silica/BCN was treated with 10% HF solution for 12 hours to completely dissolve/remove SiO₂ NPs from the product followed by washing with DI water and drying to obtain 3D-HBCN.

### Example 2: Material Characterization

Phase purity of prepared sample was studied from Powder XRD analysis which was carried out using Philips X'Pert PRO analytical diffractometer with the nickel-filtered Cu K_{α} radiation of wavelength 1.5406 Å in 10°-80° 2θ values. Raman analysis was carried out by using LabRam HR800 from JY Horiba micro Raman spectrometer instrument with 632.8 nm diode laser. Morphological study of prepared sample and post cycling electrodes were performed using NOVA NANO FESEM 450 instrument with 18 kV working potential and WD=5.2-5.7 mm. Transmission electron microscopy (TEM) was performed using IFEI, Tecnai F30, FEG microscope operating with 300 kV accelerating potential. X-ray Photoelectron Spectroscopy (XPS) measurements were carried out by using VG Micro Tech ESCA 3000 instrument with monochromatic Al K_{α} (1486.6 eV) as x-ray source and pressure for the analyser chamber was maintained at 1×10⁻⁸ mbar during measurements. The surface area study was performed using Brunauer-Emmett-Teller (BET) adsorption method with the help of Quantachrome BET surface analyser with N₂ adsorption up to 1 bar on the surface of sample.

### Example 3: Electrochemical Measurements

### Electrode Preparation: Pre-Lithiated Anode Electrode

The electrode was prepared by mixing 3D HBCN, conducting additive (super P) and PVDF binder in a ratio of 80:10:10 respectively using NMP solvent. The prepared slurry was coated on copper foil used as current collector and subsequently dried at 80° C. in oven for overnight. Circular electrodes were cut down using electrode cutter in 14 mm diameter.

### Alkali Metal Cell Fabrication:

Cells were fabricated in Ar filled glove box (oxygen level <0.1 ppm and H₂O level <0.1 ppm) in CR2032 cell type assembly with Li as counter and reference electrode and prelithiated 3D HBCN coated on copper substrate as current collector, i.e., anode. The electrolyte used was 1 M LiTFSI lithium salt (Lithium bis(trifluoromethanesulfonyl)imide dissolved in 1:1 by volume mixture of dioxolane and dimethoxyethane with 0.3 M LiNO₃ as an additive for Li-half cell. For full cell LFP, 1 M LiPF₆ in EC/DMC/EMC in 1:1:1 by v/v/v with 5% FEC was sued as electrolyte. In case of Na plating application, 1 M NaPF₆ in diglyme was used as an electrolyte. Celgard was used as separator to separate negative and positive electrodes.

### Plating-Stripping Measurements:

The plating-stripping measurements on prepared material were performed using MTI corporation battery analyzer with constant current charge-discharge.

### Example 4: Battery Performance Data

Cells were run for HBCN Li plating/stripping at different current and capacity values. In order to study morphology effect along with heteroatom doping effect, inventor have carried out Li plating/stripping on (i) Plane carbon sheets (C), (ii) Honeycomb carbon (HC) and (iii) boron carbon nitride sheets (BCN). Following is the detailed description of different samples.

### (i) Plane Carbon Sheets (C):

Plane carbon sheets (C) were synthesized by carbonization of glucose at 900° C. in Argon atmosphere for 3 h. As prepared carbon sample was characterized by XRD and Raman to analyze phase purity as shown in FIGS. 1(a) and 1(b) respectively. Two broad peaks for major crystallographic planes (002) and (001) are indicated in XRD. Two strong peaks were observed at 1334 cm⁻¹ and 1592 cm⁻¹ which correspond to D-band and G-band of graphite respectively shown in FIG. 1(b). Surface area for prepared carbon sheets as calculated from BET was 10.7 m² g⁻¹. N₂ isotherm is shown in FIG. 5(a). SEM image shown in FIG. 2(a) represents sheet like morphology for prepared sample. Li plating stripping performance for C sample at 4 mAcm⁻² current and 10 mAhcm⁻² capacity indicating very poor performance is shown from voltage vs time plot and coulombic efficiency vs cycle plot in FIGS. 9(a) and (b) respectively. This is due to very small surface area of the material which provides lower Li nucleation sites and planar surface causes inhomogeneous Li deposition which further develops into dendrite growth. Moreover, absence of hetero-doping in C results in poor anchoring of Li which ends in poor performance. Within 20 cycles of plating/stripping, coulombic efficiency drops down rapidly.

### (ii) Honeycomb Carbon (HC):

HC material was synthesized by infiltration of glucose with silica nanoparticles. After the infiltration of the solution, the resulting material was dried at 60° C., followed by pyrolysis at 900° C. in Argon gas for 3 h. Subsequently, silica NPs/Carbon composite was treated with 10% HF solution for 12 hours to completely dissolve/remove SiO₂ NPs from the product followed by washing with DI water and drying to obtain 3D HC. Phase purity of sample was characterized by XRD and Raman spectra as shown in FIGS. 1(a) and (b) respectively which indicates complete removal of silica (SiO₂) particles from material after HF treatment. 3D porous morphology of honeycomb carbon (HC) is shown in FIG. 2(b) with 276.4 m² g⁻¹ surface area. Similar to plane carbon sheets, HC sample also shows poor Li plating/stripping performance at 4 mAcm⁻² current and 10 mAhcm⁻² capacity (FIGS. 9 c and d). Coulombic efficiency drops down within 40 cycles itself. As compared to plane carbon sheets, higher surface area of HC helps in larger Li nucleation sites. However, lithio-phobic nature of carbon and lack of lithiophilic functional groups with strong binding affinity towards lithium atoms results in poor performance. Therefore, this results in inhomogeneous Li flux distribution and dendrite growth.

(iii) Boron Carbon Nitride Sheets (BCN):

BCN has been synthesized by taking equal molar ratio of boric acid, glucose and cyanamide (1:1:1) respectively and dissolved in distilled water to form a uniform solution. This solution was then heated at 70° C. till it converted into a thick paste and was completely dried. The dried material was crushed in mortar pastel and transferred in a ceramic boat to be heated in a tubular furnace at 900° C. for 3 h in Argon atmosphere. Basic material characterization for BCN like XRD, Raman, SEM and XPS to confirm phase purity and elemental analysis is shown in FIGS. 1(a), 1(b), 2(c) and 3 respectively. Li plating/stripping performance for BCN material at 4 mAcm⁻² current density and 10 mAhcm⁻² capacity value is shown in FIGS. 9 (e) and (f) respectively. Similar to planar carbon and honeycomb carbon materials, poor Li plating/stripping performance was observed for BCN material. In case of BCN, although B and N lithiophilic dopants are present, sheets like morphology provides inhomogeneous Li flux distribution in material which results in poor performance.

Battery performance of planar carbon sheets, honeycomb carbon, BCN sheets and honeycomb BCN indicates that both honeycomb structure and B—N doping into carbon are optimum requirements for uniform Li plating/stripping application.

### Example 5: Comparative Data of Performance with Other Forms of Carbon and BCN

Table 2 shows Li plating/stripping performance of different heteroatom doped carbon materials and present work of HBCN material.

TABLE 2
Comparison of different heteroatom doped carbon nanomaterials as host for lithium metal

| | | | | Full cell | |
|---|---|---|---|---|---|
| | | Current density | | performance | |
| | | (mAcm⁻²)/ | | (capacity | |
| | Surface | Capacity | | (mAhg⁻¹)/ | |
| | area | (mAhcm⁻²)/ | Full cell | current/ | |
| Material | (m² g⁻¹) | Cycles/CE(%) | with | cycles/CE (%)) | Reference |
| Nitrogen | 971 | 1/1/270/98.5 | Li-S with | 987/0.2 C/70/90 | [1] |
| doped | | | N-HPCSs/S | | |
| hollow | | | cathode | | |
| porous | | | | | |
| carbon | | | (S loading | | |
| spheres | | | 5 mgcm⁻² | | |
| (N-HPCSs) | | | | | |
| N doped | — | 2/1/90/95 | LIB with | 140/1 C/100/— | [2] |
| C rod | | | LiFePO₄ | | |
| array | | | (LFP) | | |
| | | | cathode | | |
| 3D nano | 706 | 1/1/727/NA | LIB with | 137.1/0.2 C/500/ | [3] |
| porous N | | | LiFePO₄ | 87.8 | |
| doped | | | (LFP) | | |
| graphene | | | cathode | | |
| N doped | 328 | 2/8/140/99.1 | LIB with | —/1 C/200/90 | [4] |
| graphitic | | | LiFePO4 | | |
| C foam | | | (LFP) | | |
| (NGCFs) | | | cathode | | |
| HBCN | 597 | 8/10/2437/99.98 | LIB with | 110/0.3C/50/99- | The present |
| | | | LiFePO₄(LFP) | 100 | invention work |
| | | | cathode | | |

References used in Table-2:
[1] Ye W, Pei F, Lan X, Cheng Y, Fang X, Zhang Q, Zheng N, Peng D L, Wang M S. Stable NanoEncapsulation of Lithium Through Seed Free Selective Deposition for High Performance Li Battery Anodes. Advanced Energy Materials. 2020 February; 10(7): 1902956.
[2] Chen L, Chen H, Wang Z, Gong X, Chen X, Wang M, Jiao S. Self-supporting lithiophilic N-doped carbon rod array for dendrite-free lithium metal anode. Chemical Engineering Journal. 2019 May 1; 363: 270-7.
[3] Huang G, Han J, Zhang F, Wang Z, Kashani H, Watanabe K, Chen M. Lithiophilic 3D nanoporous nitrogen doped graphene for dendrite free and ultra high rate lithium metal anodes. Advanced Materials. 2019 January; 31(2): 1805334.
[4] Liu L, Yin Y X, Li J Y, Wang S H, Guo Y G, Wan L J. Uniform lithium nucleation/growth induced by lightweight nitrogen doped graphitic carbon foams for high performance lithium metal anodes. Advanced Materials. 2018 March; 30(10): 1706216.

TABLE 3
Comparison of the present invention vis-à-vis the disclosures in the art.

| | | | Current | | | | | |
|---|---|---|---|---|---|---|---|---|
| | | Speciality | density | Capacity | | | | |
| Material | Application | of host material | (mAcm⁻²) | (mAhcm⁻²) | Cycles | CE (%) | Electrolyte | References |
| h-BN and | Li metal | 2D layer of h-BN | 2 | 5 | 50 | 97 | 1M LiPF₆ in | [1] |
| graphene | anode | and graphene | | | | | EC:DEC | |
| on Cu | | | | | | | | |
| CNF with | Li metal | Electrospun | 3 | 1 | 80 | — | 1M LiPF₆ in | [2] |
| lithiophilic | anode | carbon fiber | | | | | EC:DEC | |
| Si coating | | network | | | | | | |
| | | modified with | | | | | | |
| | | lithiophilic | | | | | | |
| | | coating-silicon | | | | | | |
| | | (Si) | | | | | | |
| ALD Al₂O₃ | Li metal | Uniformly | 0.5 | 1 | 500 | 99 | 1M LiPF₆ in | [3] |
| coated | anode | coated Al₂O₃ by | | | | | EC:DEC with | |
| hollow | | ALD technique | | | | | 1% vinylene | |
| carbon | | over HCS | | | | | carbonate | |
| spheres | | provides guided | | | | | (VC), and 10% | |
| (HCS) | | path for uniform | | | | | fluoroethylene | |
| | | Li plating | | | | | carbonate (FEC) | |
| 3D HBCN | Li/Na | High surface | LMA = 8 | LMA = 10 | LMA = 2437 | LMA = | LMA = 1M | Present |
| | metal | area HBCN with | and | and | and | 99.98 and | LiTFSI in DOL/ | invention |
| | anode | ordered porous | NMA = 8 | NMA = 2 | NMA = 1000 | NMA = | DME with 0.3M | |
| | | structure | | | | ~100 | LiNO₃ and NMA = | |
| | | provides guided | | | | | 1M NaPF₆ in | |
| | | path for Li/Na | | | | | Diglyme | |
| | | plating. | | | | | | |

References of Table 3
[1] Ultrathin Two-Dimensional Atomic Crystals as Stable Interfacial Layer for Improvement of Lithium Metal Anode by Kai Yan et. al published in Nano letters, 2014; dx.doi.org/10.1021/nl503125u | Nano Lett.
[2] Composite lithium metal anode by melt infusion of lithium into a 3D conducting scaffold with lithiophilic coating byZheng Liang et.al published in PNAS/2862-2867 | Mar. 15, 2016 | vol. 113 | no. 11.
[3] Engineering stable interfaces for three-dimensional lithium metal anodes” by JinXie et. al published in Sci. Adv. 2018; 4: eaat5168 27 July 2018.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A 3D rigid mesoporous honeycomb boron carbon nitride (HBCN) nanomaterial with porosity in the range of 300 to 500 nm and mesoporosity in the range of 2 to 10 nm as a host for plating or depositing a metal.

2. The 3D rigid mesoporous honeycomb boron carbon nitride (HBCN) nanomaterial as claimed in claim 1, wherein the nanomaterial has the surface area of 400 m² g⁻¹ to 800 m² g⁻¹.

3. The 3D rigid mesoporous honeycomb boron carbon nitride (HBCN) nanomaterial as claimed in claim 1, wherein the nanomaterial is plated or deposited with metal, where the metal is anode material is for an alkali metal ion battery.

4. The 3D rigid mesoporous honeycomb boron carbon nitride (HBCN) nanomaterial as claimed in claim 3, wherein the metal is selected from Lithium, sodium, magnesium and aluminum.

5. A process for preparing the 3D rigid mesoporous honeycomb boron carbon nitride (HBCN) nanomaterial of claim 1, the process comprising:
a) Adding tetraethyl orthosilicate (TEOS) into a mixture of water, alcohol and ammonium solution followed by stirring to afford a reaction mixture and continuing the stirring to afford silica nanoparticles;
b) Separating the silica nanoparticles of step (a) by centrifugation and washing followed by drying to afford dried colloidal silica nanoparticles (SiCh NPs);
c) Infiltrating a mixture of boric acid, carbon precursor selected from glucose, sucrose, cellulose and fructose, and cyanamide solution with colloidal SiCh NPs of step (b) and drying the resulting material followed by pyrolysis in inert gas to afford silica NPs/BCN composite; and
d) Treating the silica NPs/BCN composite of step (c) with HF to completely dissolve SiCh NPs from the product followed by washing and drying to obtain 3D honeycomb Boron Carbon Nitride (HBCN).

6. An anode material for alkali metal ion battery comprising the 3D honeycomb boron carbon nitride plated or deposited with Lithium or Sodium as claimed in claim 1.

7. A Lithium ion battery comprising the 3D honeycomb boron carbon nitride with porosity in the range from 300 to 500 nm and mesoporosity in the range of 2 to 10 nm of claim 1, which HBCN is plated or deposited with Lithium as anode.

8. The Lithium ion battery as claimed in claim 7, wherein the lithium ion battery has Li intake deposition capacity of 10 mAhcm⁻² for more than 2400 cycles and 99.98% coulombic efficiency when subjected to high current of 8 mAcm⁻².

9. A Lithium plated Full cell comprising:
a) LiFePC)4 (LFP) as cathode;
b) 3D honeycomb boron carbon nitride of claim 1 plated/deposited with lithium as anode;
c) Electrolyte comprising 1 M LiPFe₆ in Ethylene Carbonate/Dimethyl Carbonate/Ethyl Methyl Carbonate in 1:1:1 by v/v/v with 5% Fluoroethylene Carbonate as an additive; and
d) Celgard as separator to separate negative and positive electrodes.

10. The Lithium plated Full cell as claimed in claim 9, wherein the full cell has the capacity of 110 mAhg⁻¹ after 50 cycles with 100% coulombic efficiency.
